(19) United States
(12) Patent Application Publication
(10) Pub. No.: US 2024/0382036 A1
(43) Pub. Date: Nov. 21, 2024

(54) HEATING DEVICE FOR A MACHINE FOR PREPARING HOT BEVERAGES

(71) Applicant: I.R.C.A. S.P.A. INDUSTRIA RESISTENZE CORAZZATE E AFFINI, Vittorio Veneto (IT)

(72) Inventors: Christian BORTOLUZZI, Pianzano (IT); Daniele DE LUCA, Vittorio Veneto (IT); Stefano WEDAM, Mareno di Piave (IT); Federico ZOPPAS, Treviso (IT)

(21) Appl. No.: 18/577,368

(22) PCT Filed: Jun. 23, 2022
(86) PCT No.: PCT/IB2022/055819

§ 371 Date: Jan. 8, 2024

(30) Foreign Application Priority Data
Jul. 7, 2021 (IT) 102021000017891

(51) Int. Cl. A47J 31/54

(52) U.S. Cl. CPC A47J 31/542

(57) ABSTRACT

A device (1), in particular a flow through heater, for a machine for preparing hot beverages, the device (1) comprising—a metal body (2);—at least one electric heater (3) arranged in the metal body (2);—a conduit (4) for the passage of an edible liquid to be heated, in particular water; wherein said conduit (4) is delimited by a first inner surface (21) of the metal body (2); wherein said first inner surface (21) is coated with a coating layer, in particular suitable for food contact, adapted to contact the edible liquid to be heated, in particular adapted to be wet by the edible liquid to be heated; wherein said coating layer is substantially made of one of the following materials: Polyamide (PA), Perfluoroalkoxy (PFA), fluorinated ethylene propylene (FEP), Polyurethane (PU), a polyester, a silicone, or sol-gel.

### FIELD OF THE INVENTION

The present invention relates to the field of devices for preparing beverages, in particular for domestic use.

In particular, the invention relates to a heating device, more in particular an instantaneous exchanger or heater or flow through heater, adapted to heat the flow of liquid, in particular water, for preparing the beverage.

### BACKGROUND ART

Machines for preparing hot beverages, such as coffee, are very common.

Such machines are provided with a heating device adapted to heat water for preparing the beverage.

One type of heating device is referred to as a flow through heater (FTH), or flow heater or instant heater, in particular instant flow heater. A flow through heater is particularly adapted to heat a water flow, i.e., adapted to heat water as it flows in a conduit of the device.

Heating devices of the FTH type comprise a metal body, a conduit for the liquid to be heated and one or more heating elements which generate heat by Joule effect. It is desirable to make the metal body of aluminum or aluminum alloy, as it is a material which conducts heat well.

However, the aluminum metal body should not come into direct contact with the liquid to be heated, due to health concerns.

Therefore, the heating devices involve the insertion of a stainless steel tube into the metal body, so that the liquid comes into contact with the stainless steel tube and not with the metal body. The steel tube is typically brazed to the metal body.

However, the use of steel tubes has several disadvantages, including: reduced energy efficiency; adhesion of limestone to the steel tube; greater device production complexity and longer construction times.

Furthermore, the steel tube does not provide any electrical insulation between the liquid and the heating element.

Therefore, the need is felt to overcome the limitations of the prior art.

### SUMMARY OF THE INVENTION

It is an object of the present invention to provide a heating device, in particular of the FTH type, for machines for preparing beverages which is safe for health and also more energy efficient as compared to the prior art.

It is another object of the present invention to allow to produce said device in an easier and faster way as compared to the prior art.

It is another object of the present invention to increase the electrical safety of the heating device.

It is another object of the present invention to increase the limestone adhesion resistance on the wall of the liquid conduit.

The present invention achieves at least one of such objects, and other objects which will become apparent in the light of the present description, by a device, in particular a flow through heater, for machines for preparing hot beverages, the device comprising
a metal body;
at least one electric heater arranged in the metal body;
a conduit for the passage of an edible liquid to be heated, in particular water; wherein said conduit is delimited by a first inner surface of the metal body; wherein said first inner surface is coated with a coating layer, in particular suitable for food contact, adapted to contact the edible liquid to be heated, in particular adapted to be wet by the edible liquid to be heated; in particular, wherein the coating layer is made, or is substantially made, of one of the following materials: Polyamide (PA), Polytetrafluoroethylene (PTFE), Perfluoroalkoxy (PFA), Fluorinated Ethylene Propylene (FEP), Polyurethane (PU), a polyester, a silicone, or a sol-gel.

It is particularly preferred that said coating layer is made of, or substantially made of, Polyamide (PA).

As will be explained further, the aforesaid materials, in particular Polyamide, make the production process of the device easy and fast, and are also suitable for food contact. Furthermore, the aforesaid materials are suitable to withstand the temperatures which can be reached in a heating device, in particular a flow through heater, for machines for preparing hot beverages.

The aforesaid materials, in particular Polyamide, allow making said device easily and quickly, without the need to pre-treat the surface to be coated, and allow bending the conduit after coating the inner surface thereof, avoiding the coating layer from being damaged.

The invention further relates to a machine for preparing beverages, in particular according to claim 18.

The metal body is in particular provided with two distinct channels or holes, in particular through holes. One of the two holes forms said conduit for the liquid. The electric heater is arranged or made in the other hole.

The metal body is preferably made of aluminum or aluminum alloy; preferably it is an aluminum or aluminum alloy profile, in particular an aluminum or aluminum alloy extruded profile, i.e., produced by extrusion.

Advantageously, the inner surface delimiting said conduit for the liquid is provided with said coating layer, so as to prevent direct contact between the liquid and the metal body without using a steel tube, in particular without using a brazed steel tube inside one of the two holes of the metal body.

In fact, since the coating layer is suitable for food contact, and is placed between the liquid and the metal body (in use, the coating layer is wet by the liquid), it is not necessary to use the steel tube to overcome the compatibility problems related to food contact of the metal body in aluminum or aluminum alloy.

Thereby, the heat exchange efficiency between the electric heater and the liquid flowing in the conduit is also improved, i.e., a more thermally performing device is created, ensuring that the liquid flow does not come into direct contact with the metal body. In fact, there are no heat losses due to the presence of a steel tube where the liquid flows.

Furthermore, the coating layer increases the adhesion resistance of the limestone on the wall of the liquid conduit. The coating layer preferably has non-stick properties.

Also, advantageously, the electrical safety is increased by placing the coating layer between the liquid and the metal body. The coating layer is preferably electrically insulating.

In fact, the coating layer provides additional electrical insulation with respect to the electrically insulating material with which the electric heater is provided, in particular already provided.

Advantageously, moreover, by using a coating layer having a lower electrical conductivity than the material of which the metal body is made, it is possible to check easily and quickly, and in particular compatibly with mass production, whether the coating layer has been applied correctly.

Further features and advantages of the invention will become more apparent in light of the detailed description of exemplary but not exclusive embodiments.

The dependent claims describe particular embodiments of the invention.

### BRIEF DESCRIPTION OF THE DRAWINGS

In the description of the invention, reference is made to the accompanying drawings, which are provided by way of non-limiting example, in which:

FIG. 1 shows a perspective view of a device according to the invention;

FIG. 1A diagrammatically shows a sectional view of a detail of the device of FIG. 1, with an end portion of the device inserted into a tube;

FIG. 2 shows section A-A of FIG. 1;

FIG. 3 shows section A-A only of the metal body of the device of FIG. 1;

FIG. 4 shows another perspective view of the device of FIG. 1;

FIG. 5 shows a plan view of the device of FIG. 1.

The same elements or components have the same reference numerals.

### DESCRIPTION OF EXEMPLARY EMBODIMENTS OF THE INVENTION

With reference to the Figures, non-limiting exemplary embodiments of a device 1, or heating device, for a machine for preparing hot beverages, according to the invention are described.

In particular, the device 1 is of the flow through heater type, or instant heater or flow heater type.

In particular, the device 1 is adapted to be mounted in the machine for preparing hot beverages. By way of example and not by way of limitation, the machine is for preparing coffee.

In all the embodiments, the device 1 comprises
a metal body 2;
at least one electric heater 3 arranged in the metal body 2;
a conduit 4 for the passage of an edible liquid to be heated, in particular water;
wherein said conduit 4 is delimited by an inner surface 21 (also referred to as the first inner surface for descriptive purposes) of the metal body 2;
wherein said inner surface 21 is coated with a coating layer, in particular suitable for food contact, adapted to contact the edible liquid to be heated, in particular adapted to be wet by the edible liquid to be heated.

In other words, the metal body 2 is provided with two channels or holes, in particular through holes. One of the two holes forms said conduit 4 for the liquid. In the other hole 30 (FIG. 3) said electric heater 3 is arranged or made.

Each hole is delimited by a respective inner surface 21, 22 of the metal body 2.

The metal body 2 is preferably made of aluminum or aluminum alloy.

The metal body 2 is preferably a monolithic body, in particular obtained by extrusion.

The metal body 2, in particular the conduit 4, has an inlet section 242a and an outlet section 242b for the liquid.

The coating layer is made of polymer material or sol-gel.

In particular, advantageously, the coating layer is substantially made of, or is made of, one of the following materials: Polyamide (PA), Perfluoroalkoxy (PFA), fluorinated ethylene propylene (FEP), Polyurethane (PU), a polyester, a silicone, or a sol-gel.

It is particularly preferred that said coating layer is substantially made of, or made of, Polyamide (PA).

Polyamide has been carefully selected. Indeed, the Inventors have found that Polyamide offers various advantages.

In particular, Polyamide allows facilitating the production process of the device 1. In fact, Polyamide does not require pre-treatment operations of the inner surface of the conduit 4 to be coated. In particular, Polyamide does not require mechanical operations on the surface to be coated, such as abrasion of the surface to be coated to increase the roughness thereof.

Polyamide, furthermore, has suitable mechanical properties such that, to obtain a conduit 4 with one or more curved stretches, the inner surface of a metal body 2 the conduit 4 of which is straight can first be coated with polyamide; then the metal body 2 can be bent so that the conduit 4 has one or more curved stretches. In particular, by bending the inner surface 21 (coated with polyamide) delimiting the conduit 4, the Polyamide coating layer is not damaged.

Furthermore, advantageously, Polyamide allows coating a conduit 4 having an inner diameter from 2 to 10 mm, for example from 4 to 7 mm. In other words, Polyamide advantageously allows coating a conduit 4 having a very small inner diameter. The other aforesaid materials, mentioned for making the coating layer, have been identified as alternatives to Polyamide, so as to achieve the aforesaid advantages. In particular, the coating layer and the metal body 2 are made of different materials. The coating layer preferably has a thickness from 2 to 100 μm (micrometers); preferably from 5 to 25 μm.

In particular, the coating layer completely or substantially covers the inner surface 21 delimiting the conduit 4.

In particular, the coating layer has a lower electrical conductivity than the electrical conductivity of the metal body 2. In particular, the electrical conductivity of the material of which the metal body 2 is made and of the material of which the coating layer is made are evaluated under equal conditions (i.e., under the same conditions), in particular at the same temperature.

In particular, the coating layer is electrically insulating or substantially electrically insulating.

The coating layer preferably has non-stick properties, in particular with respect to limestone.

In particular, the coating layer is made of a material approved for food contact.

“Approved for food contact” preferably means approved by one or more entities, preferably by the FDA (Food and Drug Administration) and/or by the BfR (Bundesinstitut für Risikobewertung) and/or others.

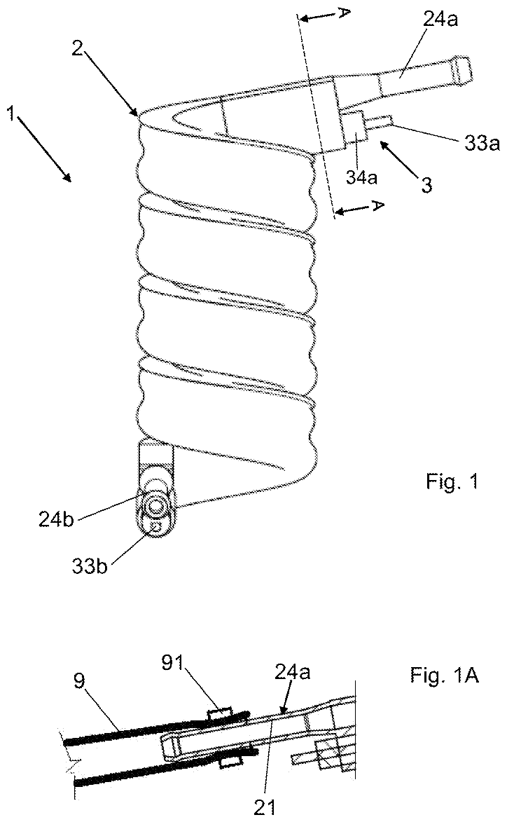

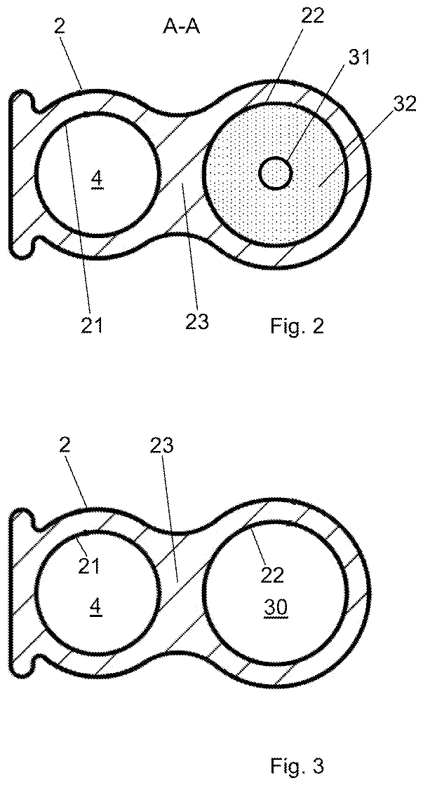

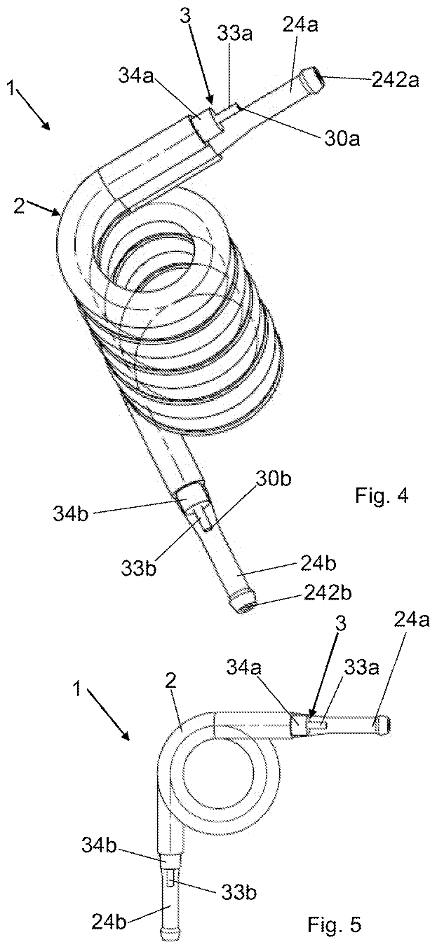

Preferably, the metal body 2, in particular monolithic, comprises two end portions 24a, 24b, or tubular end portions, each being adapted to be inserted into a respective tube 9. One of the two tubes 9 is diagrammatically shown in FIG. 1A.

The end portion 24a delimits an initial stretch of the conduit 4, and the end portion 24b delimits a final stretch of the conduit 4.

The end portion 24a comprises the opening 242a or inlet section (for the liquid) of the conduit 4, and the end portion 24b comprises the opening 242b or outlet section (for the liquid) of the conduit 4.

Part of the inner surface 21 of the conduit 4 is formed (or defined) by the end portion 24a, and part of the inner surface 21 of the conduit 4 is formed (or defined) by the end portion 24b. Therefore, also the parts of the inner surface 21 formed by the end portions 24a, 24b are provided with said coating layer.

Preferably, the length of the inner surface 21 along the axis about which it extends is greater than the length of the inner surface 22 along the axis about which it extends.

Preferably, said at least one conduit 4 has a greater length than the length of said at least one electric heater 3.

In particular, each end portion 24a, 24b protrudes, in particular outwards, with respect to the end 30a, 30b of the at least one electric heater 3 being proximal thereto.

Advantageously, thereby, the end portions 24a, 24b can be inserted into a respective tube 9, in particular into a respective flexible tube.

However, it is possible that the end portions 24a, 24b can be inserted into a respective tube 9 in other manners.

Fixing means 91 are preferably provided for fixing, in particular in a sealed manner, each tube 9 to the respective end portion 24a, 24b.

By way of mere example and not by way of limitation, each tube 9 is fixed to the respective end portion 24a, 24b by one or more clamps 91.

Preferably, the electric heater 3 and the conduit 4 each comprise a spirally wound stretch. In particular, the spirally wound stretch of the conduit 4 is arranged between the initial stretch of the conduit 4, delimited by the end portion 24a, and the final stretch of the conduit 4, delimited by the end portion 24b. Preferably, the end portion 24a and the end portion 24b are straight or substantially straight.

As an alternative to a monolithic metal body 2 comprising said end portions 24a, 24b, the metal body 2 can be provided with two tubes 24a, 24b fixed thereto, for example inserted into the metal body 2, in particular in the conduit 4. In particular, the tubes 24a, 24b can be fixed at the inlet section and the outlet section of the conduit 4, respectively. For example, the tubes 24a, 24b can be inserted into the inlet section and the outlet section of the conduit 4, respectively. Therefore, the tubes 24a, 24b and the conduit 4 define a single conduit for the passage of the liquid. Preferably, the inner surface of each of the tubes 24a, 24b is also coated with a coating layer, similarly to the inner surface 21, in particular in the same manner.

The aforesaid electric heater 3 comprises at least one electric resistor 31, or resistive element, embedded in an electrically insulating material 32.

The electric resistor 31 is for example a resistive cable or wire, preferably spirally wound, in particular about the longitudinal axis thereof.

The electrically insulating material 32 is preferably magnesium oxide.

The electrically insulating material 32 is in contact, in particular directly in contact, with the inner surface 22 (distinct from the inner surface 21) of the metal body 2.

The electric heater 3 is adapted to generate heat by Joule effect, i.e., it is adapted to generate heat when it is crossed by an electric current.

Advantageously, the coating layer coating the inner surface 21 is adapted to ensure an electrical insulation, in particular an additional electrical insulation with respect to said electrically insulating material 32, between the electric heater 3 and the edible liquid flowing in the conduit 4.

For the power supply, two pins 33a, 33b are provided, each connected to a respective end of the electric resistor 31. The pins 33a, 33b exit from the metal body 2.

In particular, two closing elements 34a, 34b made of electrically insulating material, for example ceramic material, are further provided. The closing elements 34a, 34b are fixed to the metal body 2, and are crossed by a respective pin 33a, 33b. In particular, the closing elements 34a, 34b are inserted into the hole 30 of the metal body 2 delimited by the inner surface 22.

In all the embodiments, the electric heater 3 can transfer heat to the liquid flowing in the conduit 4, through the metal body 2.

In particular, the heat generated by the electric heater 3 is transmitted to the metal body 2, which in turn transmits it to the liquid.

More in particular, the two holes 4, 30 of the metal body 2 are separated from each other by a wall 23 of the metal body 2. Preferably, a portion of the inner surface 21 and a portion of the inner surface 22 are opposite each other and are in particular portions of said wall 23.

In particular, the inner surface 21 and the inner surface 22 are continuous surfaces extending about a respective axis. In particular, said respective axis can be straight, curved, or can comprise one or more straight stretches and one or more curved stretches. Preferably, the inner surface 21 and the inner surface 22 have a circular section. Preferably, the conduit 4 has an inner diameter from 2 to 10 mm, preferably from 4 to 7 mm.

Preferably, the electric heater 3 and the conduit 4 extend parallel to each other.

Optionally, the metal body 2 can also be provided with one or more further electric heaters 3, each arranged in a respective hole of the metal body 2. Therefore, the metal body 2 can be provided with more than two distinct holes or channels.

As already mentioned, the invention further relates to a machine for preparing beverages comprising a device 1.

Preferably, the machine can comprise two tubes 9, in particular two flexible tubes. One of the two tubes 9 is diagrammatically shown in FIG. 1A.

A first tube of said two tubes 9 is adapted to conduct the liquid to be heated in the conduit 4, and the other tube (or second tube) of the two tubes is adapted to receive the heated liquid exiting from the conduit 4.

In particular, the first end portion 24a of the metal body 2 is inserted into the first tube 9, and the second end portion 24b of the metal body 2 is inserted into the second tube.

Fixing means 91 are preferably provided for fixing, in particular in a sealing manner, each tube 9 to the respective end portion 24a, 24b.

By way of mere example and not by way of limitation, each tube 9 is fixed to the respective end portion 24a, 24b by one or more clamps 91.

A device 1 according to the invention offers several advantages, including those listed below.

The presence of the coating layer coating the inner surface 21 allows making the metal body 2 of aluminum or aluminum alloy, so as to transmit heat well, and avoiding the use of a tube, for example made of stainless steel, inside the hole delimited by the inner surface 21. In fact, since the coating layer is suitable for food contact, and is interposed between the liquid and the metal body 2 (the coating layer is wet by the liquid), it is not necessary to use the steel tube to overcome the compatibility problems related to food contact of the metal body 2 in aluminum or aluminum alloy.

The heat exchange efficiency between the electric heater 3 and the liquid flowing in the conduit 4 is also improved. In fact, there are no heat losses due to the presence of a steel tube where the liquid flows.

Furthermore, the coating layer allows increasing the adhesion resistance of the limestone on the wall of the conduit 4.

Advantageously, the electrical safety is further increased by placing the coating layer between the liquid and the metal body 2, as previously explained.

Advantageously, moreover, by using a coating layer having a lower electrical conductivity than the material of which the metal body 2 is made, it is possible to check, easily and quickly, and in particular compatibly with mass production, whether the coating layer has been applied correctly.

1. A device, in particular a flow through heater, for a machine for preparing hot beverages,
the device comprising
a metal body;
at least one electric heater arranged in the metal body;
a conduit for the passage of an edible liquid to be heated, in particular water;
wherein said conduit is delimited by a first inner surface of the metal body;
wherein said first inner surface is coated with a coating layer, in particular suitable for food contact, adapted to contact the edible liquid to be heated, in particular adapted to be wet by the edible liquid to be heated;
wherein said coating layer is substantially made of one of the following materials: Polyamide (PA), Perfluoroalkoxy (PFA), fluorinated ethylene propylene (FEP), Polyurethane (PU), a polyester, a silicone, or sol-gel.

2. The device according to claim 1, wherein said metal body is made of aluminum or aluminum alloy.

3. The device according to claim 1, wherein said metal body is a monolithic body, in particular obtained by extrusion.

4. The device according to claim 1, wherein said coating layer has a thickness from 2 to 100 μm; preferably from 5 to 25 μm.

5. The device according to claim 1, wherein said coating layer has a lower electrical conductivity than the electrical conductivity of said metal body; in particular wherein the electrical conductivities are assessed under the same conditions.

6. The device according to claim 1, wherein said coating layer is made of a material which is suitable for food contact.

7. The device according to claim 1, wherein said coating layer is made of a material approved for food contact.

8. The device according to claim 1, wherein said conduit has one or more curved stretch.

9. The device according to claim 1, wherein said coating layer is substantially made of Polyamide (PA).

10. The device according to claim 1, wherein said at least one electric heater comprises at least one electric resistor embedded in an electrically insulating material; wherein said electrically insulating material is in contact, in particular directly in contact, with a second inner surface of the metal body.

11. The device according to claim 1, wherein said coating layer is adapted to ensure an electrical insulation, in particular an additional electrical insulation with respect to said electrically insulating material, between said at least one electric heater and the edible liquid flowing in the conduit.

12. The device according to claim 1, wherein said first inner surface and said second inner surface are continuous surfaces which extend about a respective axis; preferably wherein said first inner surface and said second inner surface have a circular section.

13. The device according to claim 1, wherein said at least one electric heater and said conduit extend parallel to each other.

14. The device according to claim 1, wherein said conduit has an inner diameter from 2 to 10 mm; preferably from 4 to 7 mm.

15. The device according to claim 1, wherein the metal body comprises a first end portion and a second end portion, delimiting an initial stretch and a final stretch of said conduit, respectively, and in particular form a respective portion of said inner surface;
wherein the first end portion and the second end portion are adapted to be inserted into a respective tube.

16. The device according to claim 15, wherein said conduit has a greater length than the length of said at least one electric heater; in particular so that the first end portion and the second end portion are adapted to be inserted into the respective tube.

17. The device according to claim 15, wherein each end portion protrudes, in particular outwards, with respect to the end of the at least one electric heater being proximal thereto.

18. A machine for preparing beverages comprising a device according to claim 1.
